(19) United States
(12) Patent Application Publication
(10) Pub. No.: US 2025/0153583 A1
(43) Pub. Date: May 15, 2025

(54) THREE-TYPE SELF-POWER GENERATION SYSTEM FOR CHARGING ELECTRIC VEHICLE BATTERY

(71) Applicant: Billian Ducwong HYUN, Artesia, CA (US)

(72) Inventor: Billian Ducwong HYUN, Artesia, CA (US)

(21) Appl. No.: 18/588,940

(22) Filed: Feb. 27, 2024

(30) Foreign Application Priority Data
Nov. 13, 2023 (KR) 10-2023-0156146

(51) Int. Cl. B60L 53/00; B60L 8/00

(52) U.S. Cl. CPC B60L 53/00; B60L 8/003; B60L 8/006

(57) ABSTRACT

Provided is a three-type self-power generation system for charging an electric vehicle battery. The three-type self-power generation system includes: a fixed panel formed on an outer ceiling surface of an electric vehicle while supported by a support column; one or more first power generators which are formed in a space between the outer ceiling surface of the electric vehicle and the fixed panel and generate electricity using wind power to charge a battery of the electric vehicle; one or more second power generators which are formed on a lower surface of the vehicle and generate electricity using a rotational force to charge the battery of the electric vehicle while the vehicle travels; and one or more third power generators which are formed on a flat surface of the fixed panel and generate electricity using sunlight to charge the battery of the electric vehicle.

### BACKGROUND

### 1. Field of the Invention

The present invention relates to power generation technology for charging an electric vehicle battery, and more specifically, to a three-type self-power generation system for charging an electric vehicle battery that can charge battery packs of an electric vehicle through one or more power generation apparatuses using eco-friendly energy.

### 2. Discussion of Related Art

In a battery for an electric vehicle, a plurality of battery cell units are closely coupled to form a module in order to ensure stable capacity, a plurality of modules are coupled to form a battery pack having sufficient capacity, and the battery pack is separately or integrally mounted on a bottom surface of the electric vehicle.

Meanwhile, such a battery pack for an electric vehicle has high capacity and is charged by a charger provided in a separate charging station, but has a disadvantage of taking a long charge time.

### SUMMARY OF THE INVENTION

The present invention is directed to providing a three-type self-power generation system for charging an electric vehicle battery in which self-power generation apparatuses for generating electricity using sunlight, wind power, and rotational force of a wheel are formed in an electric vehicle to reduce various inconveniences occurring when a battery pack is charged in a charging station and a cost for charging the battery pack through the charging station.

According to an aspect of the present invention, there is provided a three-type self-power generation system for charging an electric vehicle battery, including a fixed panel formed on an outer ceiling surface of an electric vehicle to be supported by a support column, one or more first power generators which are formed in a space between the outer ceiling surface of the electric vehicle and the fixed panel and generate electricity using wind power to charge a battery of the electric vehicle, one or more second power generators which are formed on a lower surface of the vehicle and generate electricity using a rotational force to charge the battery of the electric vehicle while the vehicle travels, and one or more third power generators which are formed on a flat surface of the fixed panel and generate electricity using sunlight to charge the battery of the electric vehicle.

The first power generator may include a first rotary shaft of which both ends are rotatably coupled to the outer ceiling surface of the electric vehicle and an inner surface of the fixed panel, a wing which is formed on an outer circumferential surface of the first rotary shaft and rotated by wind introduced into the space between the outer ceiling surface of the electric vehicle and the fixed panel to rotate the first rotary shaft, a first rotator which is coupled to an outer circumferential surface of one end of the first rotary shaft and in which a first through hole through which the first rotary shaft passes is formed in a central portion of the first rotator and a plurality of magnets are disposed on an adjacent surface around the first through hole, and a first stator which is fixed to the outer ceiling surface of the electric vehicle and faces the first rotator, in which a first bearing to which the first rotary shaft passing through the first through hole is coupled is formed in a central portion of the first stator, a first stator coil is disposed on an adjacent surface around the first bearing, and which generates the electricity according to rotation of the first rotator to charge the battery of the electric vehicle.

The first magnet may be permanent magnets in which N-pole and S-pole are alternately disposed.

Each of the first rotator the first stator may be a disc type structure.

One or more base plates may be formed on the inner surface of the fixed panel, a second bearing coupled to the other end of the first rotary shaft may be connected to the base plate, and the base plate and the second bearing may be connected to an elastic rubber spring which prevents the first rotator from being separated from the first stator.

The second power generator may include a pair of suspensions which are formed on the lower surface of the electric vehicle and connected to face each other through a connecting shaft, a pair of second stators facing each other, which are fixed to both ends of the connecting shaft connecting the suspensions and on which second stator coils for generating the electricity to charge the battery of the electric vehicle are disposed, a second rotator which includes a third bearing to be rotatably coupled to the connecting shaft between the pair of first stators and in which a plurality of second magnets are disposed on both adjacent surfaces around the third bearing so that the plurality of second stator coils generate the electricity, and a tire which is fastened to an outer circumference of the second rotator and comes into contact with a ground surface to rotate the second rotator while the vehicle travels.

The second magnet may be permanent magnets in which N-pole and S-pole are alternately disposed.

The second stator may be a cylindrical structure, and the second rotator may be a tire rim-shaped structure which covers an outer surface of one end of the second stator.

Facing surfaces of the second stator and the second rotator may be formed as an uneven portion formed in a male-female shape for collecting rainwater.

A board having a suspension holder and a support plate may be formed on the lower surface of the electric vehicle, and the suspensions may be supported by the support plate.

The third power generator may be one or more sunlight collecting plates.

Electrical charge lines of the first power generator, the second power generator, and the third power generator may be connected to the battery or a solar power generator in parallel, a on or off contact part may be formed on the electrical charge line to determine whether to charge the battery or the solar power generator, and the on or off contact part may be configured to controlled by a control switch on a driver's seat of the vehicle.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating an overall structure of a three-type self-power generation systems for charging a camping electric vehicle battery according to an embodiment of the present invention;

FIG. 2 is a side view illustrating the overall structure of the three-type self-power generation systems for charging the camping electric vehicle battery according to the embodiment of the present invention;

FIG. 3 is an exploded perspective view illustrating a structure of a first power generator using wind power according to the embodiment of the present invention;

FIG. 4 is a schematic plan view illustrating a structure of a stator of the first power generator according to the embodiment of the present invention;

FIG. 5 is a schematic plan view illustrating a structure of a rotator of the first power generator according to the embodiment of the present invention;

FIG. 6 is a schematic cross-sectional view illustrating a coupling structure of the first power generator using wind power according to the embodiment of the present invention;

FIG. 7 is an enlarged bottom perspective view illustrating an electric vehicle to which a second power generator is applied according to the embodiment of the present invention;

FIG. 8 is an exploded perspective view illustrating a structure of the second power generator according to the embodiment of the present invention;

FIG. 9 is a schematic plan view illustrating a structure of a rotator of the second power generator according to the embodiment of the present invention;

FIG. 10 is a schematic plan view illustrating a structure of a stator of the second power generator according to the embodiment of the present invention;

FIG. 11 is a schematic cross-sectional plan view illustrating a coupling structure of the second power generator according to the embodiment of the present invention; and

FIG. 12 is a side view illustrating an overall structure of a three-type self-power generation system for charging a passenger electric vehicle battery according to the embodiment of the present invention.

### DETAILED DESCRIPTION OF EXEMPLARY EMBODIMENTS

It should be understood that various embodiments of the invention are different but are not necessarily mutually exclusive. For example, specific shapes, structures, and characteristics of the embodiments described herein may be implemented in other embodiments without departing from the scope and spirit of the present invention. In addition, it should be understood that a position or arrangement of each component in each disclosed embodiment may be changed without departing from the scope and spirit of the invention. Like numbers refer to the same or like functions throughout the descriptions of the drawings.

Hereinafter, embodiments of the present invention will be described with reference to the accompanying drawings.

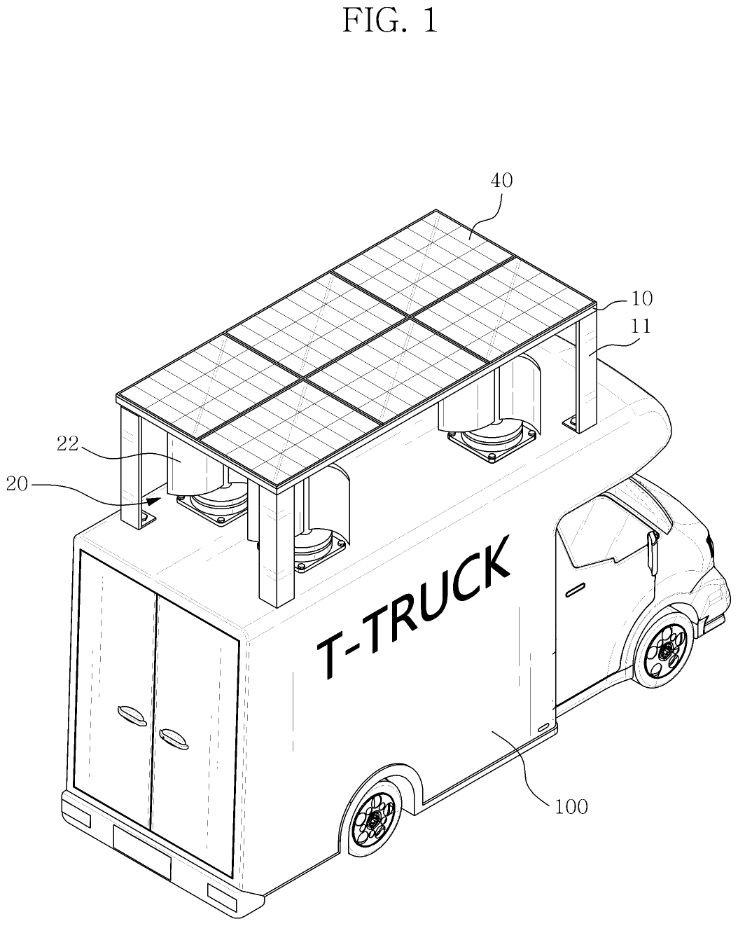

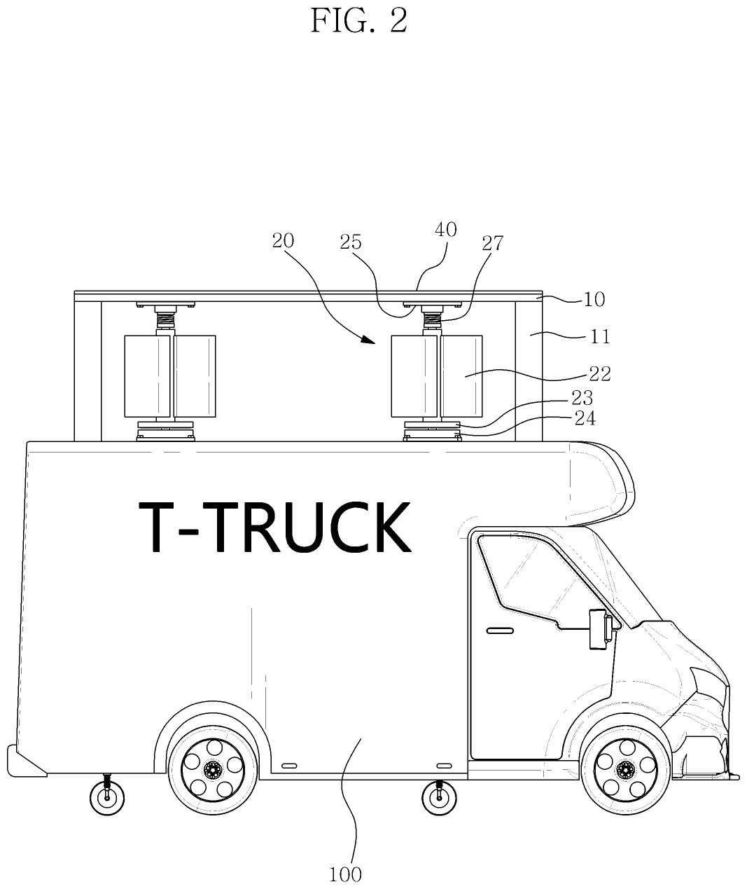

FIG. 1 is a perspective view illustrating an overall structure of a three-type self-power generation system for charging an electric vehicle battery according to an embodiment of the present invention, and FIG. 2 is a side view illustrating the overall structure of the three-type self-power generation system for charging an electric vehicle battery according to the embodiment of the present invention.

The three-type self-power generation system for charging an electric vehicle battery according to the embodiment of the present invention includes a fixed panel 10, a first power generator 20, a second power generator 30, and a third power generator 40 as illustrated in accompanying FIGS. 1 and 2.

The fixed panel 10 is formed on an outer ceiling surface of an electric vehicle 100 while supported by support columns 11.

That is, the support columns 11 are four column structures, and when the fixed panel 10 is installed on the outer ceiling surface of the electric vehicle 100 through the support columns 11, a space through which wind is introduced and passes may be provided between the outer ceiling surface of the electric vehicle 100 and the fixed panel 10.

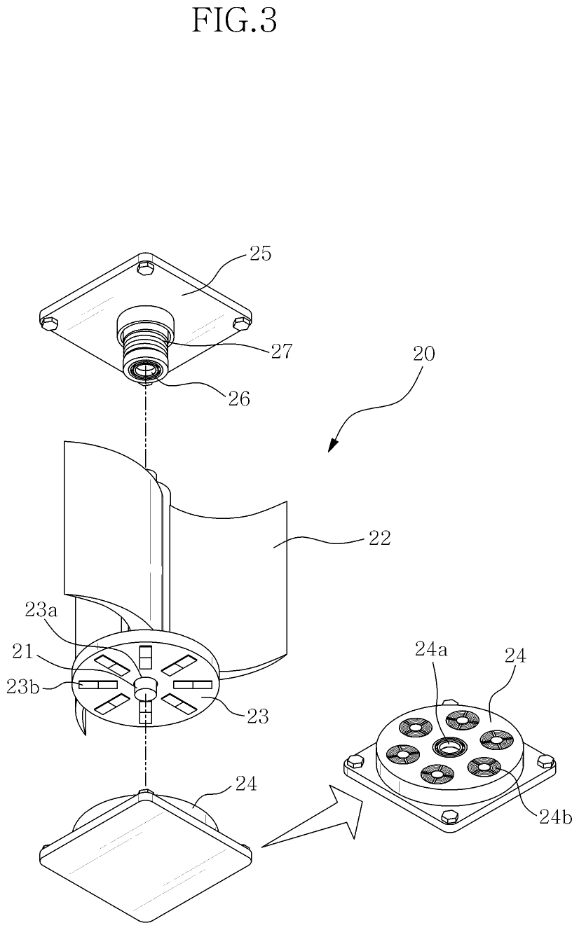

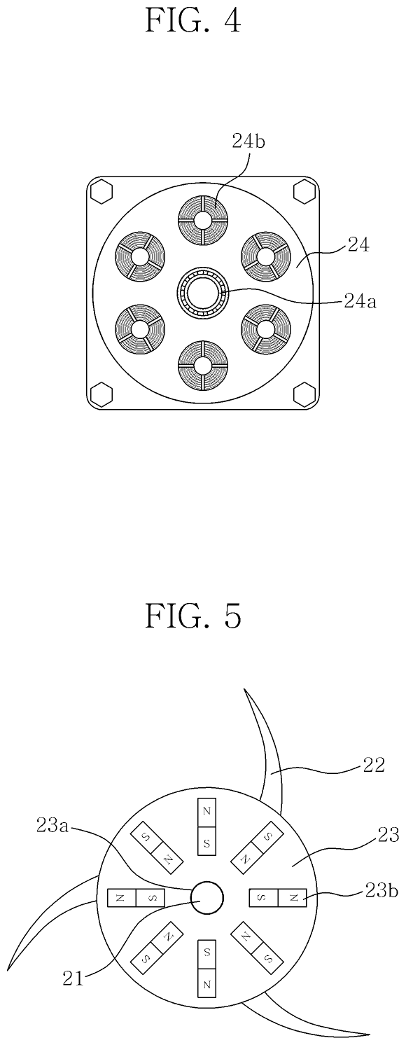

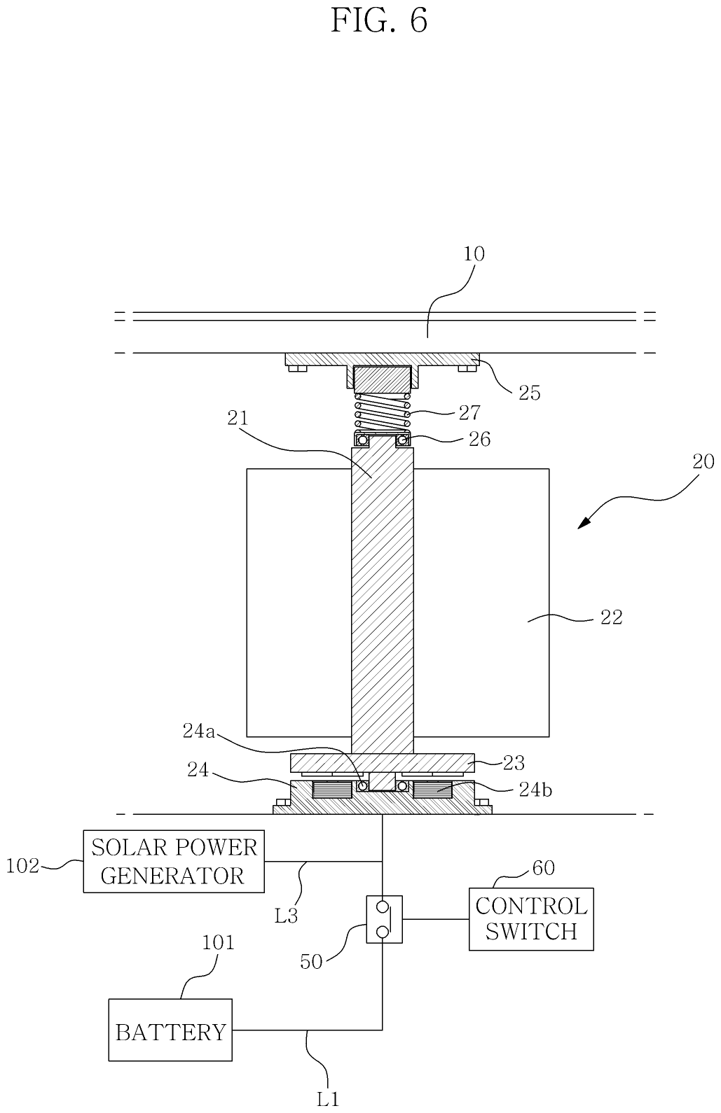

As illustrated in FIGS. 3 to 6, the first power generator 20 is provided as one or more first power generators 20 formed in a space between the outer ceiling surface of the electric vehicle 100 and the fixed panel 10. Each of the first power generators 20 may generate electricity using wind power to charge a battery 101 of the electric vehicle 100, include a first rotary shaft 21, wings 22, a first rotator 23, and a first stator 24, and further include a base plate 25, a second bearing 26, and an elastic rubber spring 27.

Both ends of the first rotary shaft 21 are rotatably coupled to the outer ceiling surface of the vehicle and an inner surface of the fixed panel 10.

That is, one end of the first rotary shaft 21 may be rotatably coupled to a first bearing 24a, which will be described below, included in the first stator 24. The other end of the first rotary shaft 21 may be rotatably coupled to the second bearing 26 connected to the base plate 25 formed on the inner surface of the fixed panel 10 using the elastic rubber spring 27.

The elastic rubber spring 27 connects the base plate 25 to the second bearing 26 and prevents the first rotator 23 from being separated from the first stator 24.

The wings 22 are formed on an outer circumferential surface of the first rotary shaft 21 and rotated by wind introduced through the space between the outer ceiling surface of the electric vehicle 100 and the fixed panel 10 to rotate the first rotary shaft 21.

That is, in a state in which the electric vehicle 100 is traveling, stopped, or parked, when external wind is introduced, the wings 22 rotate to rotate the first rotary shaft 21.

The first rotator 23 may be a disc type structure and may be fixedly coupled to an outer circumferential surface of one end of the first rotary shaft 21. A first through hole 23a through which the first rotary shaft 21 passes is formed in a central portion of the first rotator 23, and a plurality of first magnets 23b may be disposed on an adjacent surface around the first through hole 23a.

In this case, the plurality of first magnets 23b are permanent magnets in which N-pole and S-pole are alternately disposed.

The first stator 24 is a disc type structure that is fixed to the outer ceiling surface of the vehicle and faces the first rotator 23. The first bearing 24a, to which one end of the first rotary shaft 21 passing through the first through hole 23a is coupled, may be formed in a central portion of the first stator 24, and first stator coils 24b facing the first magnets 23b may be disposed on an adjacent surface around the first bearing 24a. Electricity for charging the battery 101 is generated according to rotation of the first rotator 23.

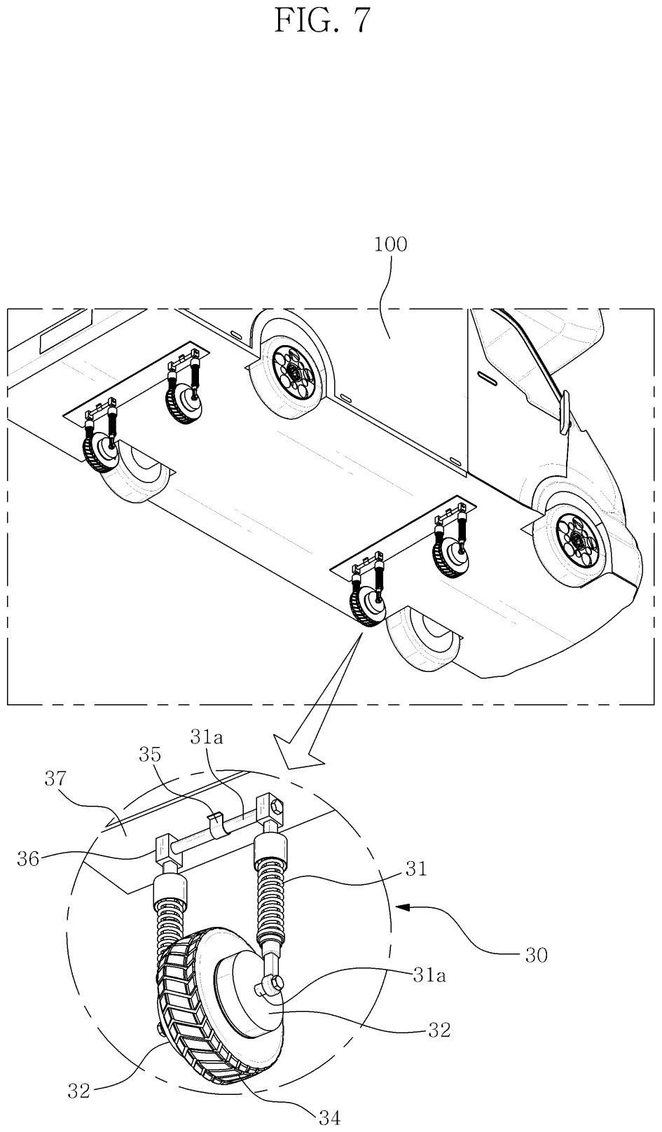

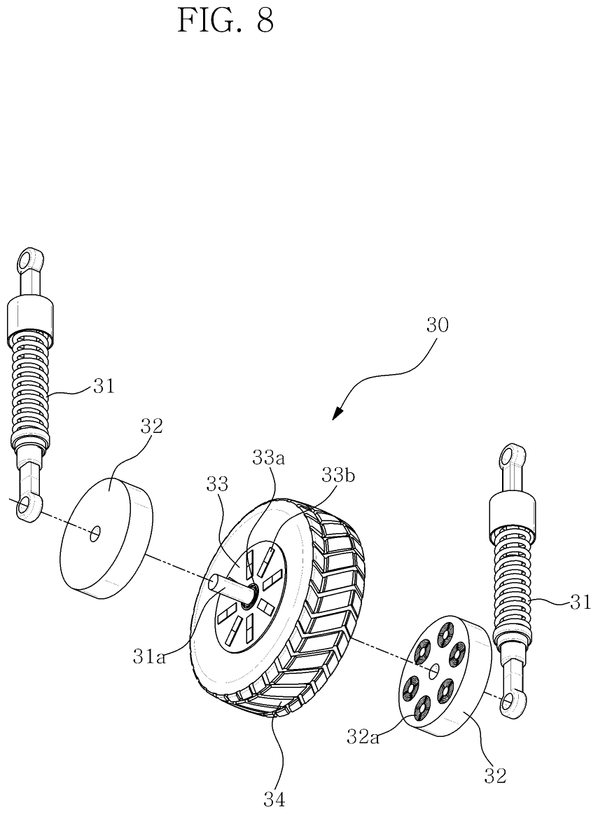

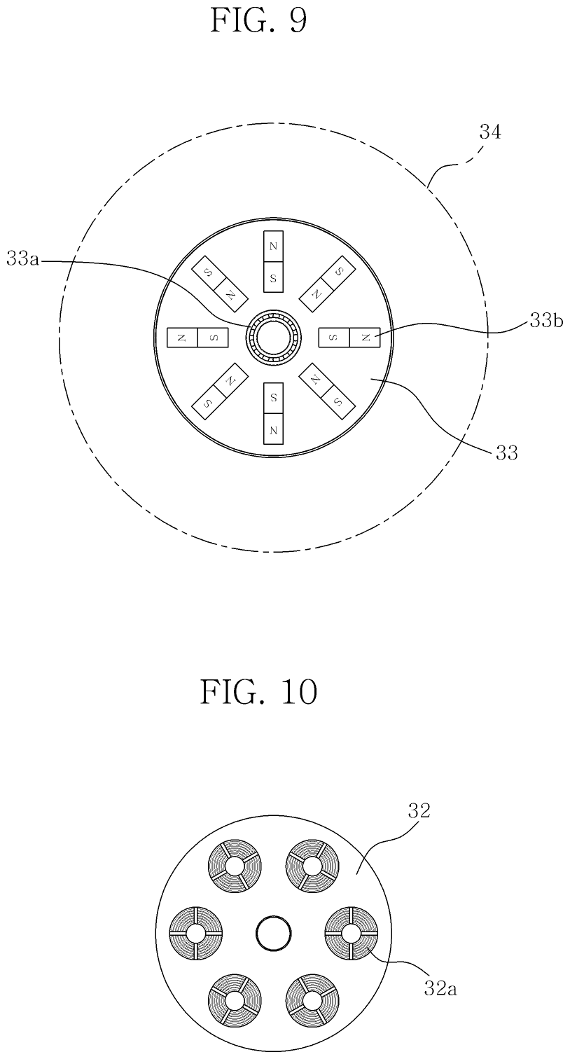

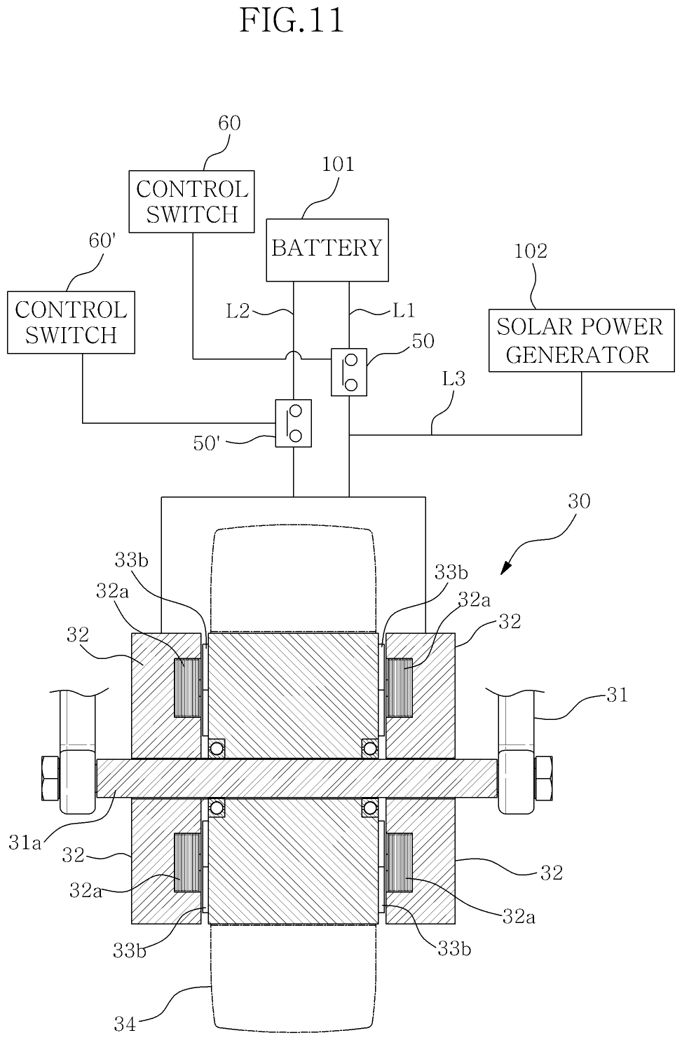

As illustrated in accompanying FIGS. 7 to 11, the second power generator 30 may be provided as one or more second power generators 30 formed on a lower surface of the electric vehicle 100, each of the second power generators 30 may generate electricity using a rotational force while the vehicle travels to charge the battery 101 of the electric vehicle 100 and may include a suspension 31, a second stator 32, a second rotator 33, and a tire 34.

The suspension 31 is provided as a pair of structures facing each other that are connected through a connecting shaft 31a on the lower surface of the electric vehicle 100.

A board 37 having a suspension holder 35 and a support plate 36 is formed on the lower surface of the electric vehicle 100, and the suspensions 31 may be supported by the support plate 36.

The second stator 32 may be a cylindrical structure and may be fixed to each of both ends of the connecting shaft 31a connecting the pair of facing suspensions 31. A second stator coil 32a which generates electricity for charging the battery 101 may be disposed on the second stator 32.

The second rotator 33 may be a tire rim-shaped structure which covers outer surfaces of one ends of a pair of second stators 32 facing each other and may have a third bearing 33a to be rotatably coupled to the connecting shaft 31a between the pair of first stators 32 facing each other. A plurality of second magnets 33b are disposed on both adjacent surfaces around the third bearing 33a so that the plurality of the second stator coils 32a generate electricity.

In this case, the plurality of second magnets 33b are permanent magnets in which N-pole and S-pole are alternately disposed.

The tire 34 is fastened to an outer circumference of the second rotator 33 and comes into contact with a ground surface to rotate the second rotator 33 when the vehicle travels.

In addition, as an embodiment of the present invention, an uneven portion (not shown) formed in a male-female shape may be formed as a rainwater collection between the second stator 32 and the second rotator 33. This is to prevent rainwater from being collected between the second stator 32 and the second rotator 33, which interferes with power generation in a wet or snowy area.

The third power generator 40 is provided as one or more third power generators 40 formed on a flat surface of the fixed panel 10, and the third power generators 40 are one or more sunlight collecting plates which generate electricity using sunlight to charge the battery 101 of the electric vehicle 100.

Meanwhile, electrical charge lines L1, L2, and L3 of the first power generator 20, the second power generator 30, and the third power generator 40 may be connected to the battery 101 and/or a solar power generator 102 in parallel. In this case, a contact part 50 to be turned on or off for determining whether the battery 101 and/or the solar power generator 102 is charged may be formed on the electrical charge line L1 and/or L3 of the first power generator 20 and the second power generator 30. A contact part 50′ to be turned on or off for determining whether to or not to perform charging may be formed on the electrical charge line L2 of the second power generator 30. The turning on or off of the contact parts 50 and/or 50′ may be configured to be controlled through control switches 60 and/or 60′ on a driver's seat of the vehicle to stop the charging of the battery 101.

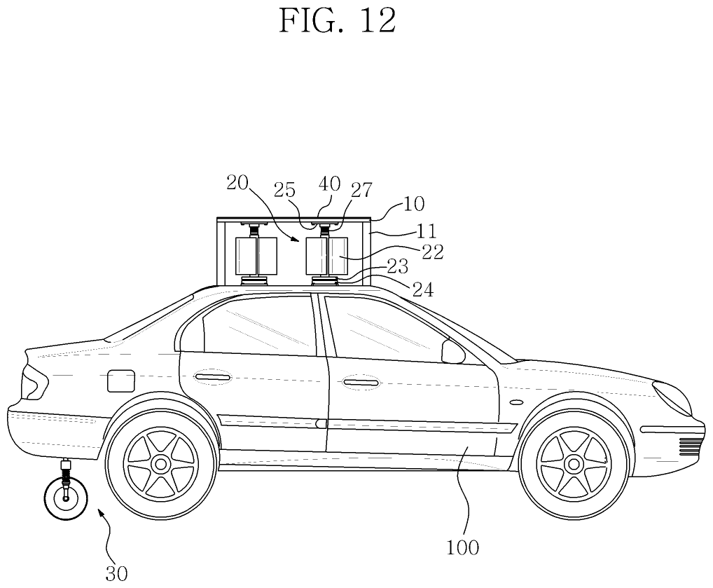

As described above, in the three-type self-power generation system for electric vehicle battery charging according to the embodiment of the present invention, as illustrated in FIGS. 1 to 12, in a state in which the camping or passenger electric vehicle 100 is stopped or parked, the battery 101 may be charged through the third power generator 40 and the solar power generator 102 using sunlight. In the state in which the electric vehicle 100 is stopped or parked, when a strong wind blows, the battery 101 may be charged through the first power generator 20 using wind power.

On the other hand, in a state in which the electric vehicle 100 travels, the battery 101 may be charged through the third power generator 40 using sunlight, as well as the first power generator 20 using wind power, and the second power generator 30 using driving rotational force.

Meanwhile, even when charging of the battery 101 through the third power generator 40 using sunlight is restricted, in a state in which the vehicle travels, the battery 101 may be sufficiently charged through the first power generator 20 and the second power generator 30. Accordingly, a driver using the electric vehicle 100 can reduce the inconvenience of visiting and waiting for a charging station, reduce a cost of paying electric charges for charging, and drive the electric vehicle 100 continuously for a long time.

As described above, in the present invention, a three-type self-power generation system that generates electricity using sunlight, wind power, and rotational force of a wheel is formed in an electric vehicle, and thus effects of removing various inconveniencies occurring when a battery pack is charged in a charging station and a cost for charging the battery pack through the charging station can be expected.

Effects of the present invention are not limited to the above-described effects, and other effects which are not described above will be clearly understood by those skilled in the art through the description of the scope of the claims.

While the technical spirit of the three-type self-power generation system for electric vehicle battery charging of the present invention has been described with reference to the accompanying drawings, this is only an illustrative description of the exemplary embodiments of the present invention, and does not limit the present invention.

Accordingly, the present invention is not limited to the above-described specific exemplary embodiments and may be variously modified by those skilled in the art without departing from the gist of the invention claimed by the appended claims, and the modifications are within the scope of the claims.

What is claimed is:

1. A three-type self-power generation system for charging an electric vehicle battery, comprising:
a fixed panel formed on an outer ceiling surface of an electric vehicle while supported by a support column;
one or more first power generators which are formed in a space between the outer ceiling surface of the electric vehicle and the fixed panel and generate electricity using wind power to charge a battery of the electric vehicle;
one or more second power generators which are formed on a lower surface of the vehicle and generate electricity using a rotational force to charge the battery of the electric vehicle while the vehicle travels; and
one or more third power generators which are formed on a flat surface of the fixed panel and generate electricity using sunlight to charge the battery of the electric vehicle.

2. The three-type self-power generation system of claim 1, wherein the first power generator includes:
a first rotary shaft of which both ends are rotatably coupled to the outer ceiling surface of the electric vehicle and an inner surface of the fixed panel;
a wing which is formed on an outer circumferential surface of the first rotary shaft and rotated by wind introduced into the space between the outer ceiling surface of the electric vehicle and the fixed panel to rotate the first rotary shaft;
a first rotator which is coupled to an outer circumferential surface of one end of the first rotary shaft and in which a first through hole through which the first rotary shaft passes is formed in a central portion of the first rotator and a plurality of magnets are disposed on an adjacent surface around the first through hole; and
a first stator which is fixed to the outer ceiling surface of the electric vehicle and faces the first rotator, in which a first bearing to which the first rotary shaft passing through the first through hole is coupled is formed in a central portion of the first stator, a first stator coil is disposed on an adjacent surface around the first bearing, and which generates the electricity according to rotation of the first rotator to charge the battery of the electric vehicle.

3. The three-type self-power generation system of claim 2, wherein the first magnet includes permanent magnets in which N-pole and S-pole are alternately disposed.

4. The three-type self-power generation system of claim 2, wherein each of the first rotator the first stator is a disc type structure.

5. The three-type self-power generation system of claim 2, wherein:
one or more base plates are formed on the inner surface of the fixed panel;
a second bearing coupled to the other end of the first rotary shaft is connected to the base plate; and
the base plate and the second bearing are connected to an elastic rubber spring which prevents the first rotator from being separated from the first stator.

6. The three-type self-power generation system of claim 1, wherein the second power generator includes:
a pair of suspensions which are formed on the lower surface of the electric vehicle and connected to face each other through a connecting shaft;
a pair of second stators facing each other which are fixed to both ends of the connecting shaft connecting the suspensions and on which second stator coils for generating the electricity to charge the battery of the electric vehicle are disposed;
a second rotator which includes a third bearing to be rotatably coupled to the connecting shaft between the pair of first stators and in which a plurality of second magnets are disposed on both adjacent surfaces around the third bearing so that the plurality of second stator coils generate the electricity; and
a tire which is fastened to an outer circumference of the second rotator and comes into contact with a ground surface to rotate the second rotator while the vehicle travels.

7. The three-type self-power generation system of claim 6, wherein the second magnet includes permanent magnets in which N-pole and S-pole are alternately disposed.

8. The three-type self-power generation system of claim 6, wherein:
the second stator is a cylindrical structure; and
the second rotator is a tire rim-shaped structure which covers an outer surface of one end of the second stator.

9. The three-type self-power generation system of claim 6, wherein facing surfaces of the second stator and the second rotator are formed as an uneven portion formed in a male-female shape for collecting rainwater.

10. The three-type self-power generation system of claim 6, wherein:
a board having a suspension holder and a support plate is formed on the lower surface of the electric vehicle; and
the suspensions are supported by the support plate.

11. The three-type self-power generation system of claim 1, wherein the third power generator includes one or more sunlight collecting plates.

12. The three-type self-power generation system of claim 1, wherein:
electrical charge lines of the first power generator, the second power generator, and the third power generator are connected to the battery or a solar power generator in parallel;
an on or off contact part is formed on the electrical charge line to determine whether to charge the battery or the solar power generator; and
the on or off the contact part is configured to be controlled by a control switch on a driver's seat of the vehicle.
